(19) United States
(12) Patent Application Publication
(10) Pub. No.: US 2024/0190274 A1
(43) Pub. Date: Jun. 13, 2024

(54) ELECTRIC VEHICLE AND CONTROL METHOD OF SAME

(71) Applicants: Hyundai Motor Company, Seoul (KR); Kia Corporation, Seoul (KR)

(72) Inventors: Yong Jae LEE, Yongin-si (KR); Young Kwan KO, Seoul (KR); Byung Kwan SON, Suwon-si (KR); Jang Yoon JEONG, Hwaseong-si (KR); Ho Tae CHUN, Asan-si (KR); Yoo Jong LEE, Osan-si (KR)

(73) Assignees: Hyundai Motor Company, Seoul (KR); Kia Corporation, Seoul (KR)

(21) Appl. No.: 18/218,219

(22) Filed: Jul. 5, 2023

(30) Foreign Application Priority Data
Dec. 8, 2022 (KR) 10-2022-0170861

(51) Int. Cl. B60L 53/24; B60L 50/60; H02J 7/00; H02J 7/34

(52) U.S. Cl. CPC B60L 53/24; B60L 50/66; H02J 7/0024; H02J 7/0068; H02J 7/007182; H02J 7/342; B60L 2240/547; H02J 2310/48

(57) ABSTRACT

An electric vehicle includes a main battery and an auxiliary battery, a motor system including a motor and an inverter, and a controller which is configured to control an external voltage to be applied to the main battery or the auxiliary battery according to a level of the external voltage when a charging mode for charging the main battery and the auxiliary battery is performed, wherein the motor system is configured to step down and output a voltage of the main battery to the auxiliary battery when the external voltage is applied to the main battery, and is configured to boost and output a voltage of the auxiliary battery to the main battery when the external voltage is applied to the auxiliary battery.

### CROSS REFERENCE TO RELATED APPLICATION

The present application claims priority to Korean Patent Application No. 10-2022-0170861, filed Dec. 8, 2022, the entire contents of which is incorporated herein for all purposes by this reference.

### BACKGROUND OF THE PRESENT DISCLOSURE

### Field of the Present Disclosure

The present disclosure relates to an electric vehicle having a main battery and an auxiliary battery, and a control method of the same.

### Description of Related Art

Recently, according to the global trend of carbon dioxide reduction in emission, demand for electric vehicles, which generate driving power by driving a motor with electrical energy stored in a battery, is greatly increasing to replace internal combustion engine vehicles that generate driving power through combustion of fossil fuel.

The battery charging time of an electric vehicle is longer than the refueling time of an internal combustion engine vehicle, and thus the maximum driving distance of the electric vehicle which may be driven with one full charge of a battery is important.

The maximum driving distance of the electric vehicle may vary depending on the voltage and capacity of a battery. Even if batteries have the same capacity, voltage and charge thereof may be different depending on a combination of series/parallel connection between modules or cells. For example, the voltage of a battery may correspond to a value obtained by multiplying the voltage of battery cells by the number of the cells connected in series, and the charge amount of a battery may correspond to a value obtained by multiplying the charge amount of battery cells by the number of cells connected in parallel.

When the voltage of a battery is a designed reference voltage or more, a motor system of the electric vehicle can produce the maximum available output power, but when the voltage of the battery is less than the designed reference voltage, available output power is limited. Limitation of the available output power may cause the power performance of the electric vehicle to deteriorate. Accordingly, a method of increasing the voltage of a battery may be considered, but when the voltage of the battery increases, the withstand voltage design of the motor system is required to be strengthened, so the present method also has limitations.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric vehicle including a main battery and an auxiliary battery and a control method of the same.

The present disclosure is directed to efficiently increase the driving distance of the electric vehicle by charging the main battery with the auxiliary battery through a motor system while driving of the vehicle of the electric vehicle.

Furthermore, the present disclosure is directed to efficiently charge the main battery and the auxiliary battery through the motor system regardless of a level of an external voltage during fast charging.

Technical objectives to be achieved in an exemplary embodiment of the present disclosure are not limited to the technical objective mentioned above, and other technical objectives not mentioned above will be clearly understood to those skilled in the art to which an exemplary embodiment of the present disclosure belongs from the following description.

In an aspect of the present disclosure, there is provided an electric vehicle including: a main battery and an auxiliary battery: a motor system including a motor and an inverter and connected to the main battery and the auxiliary battery: and a controller which is configured to control an external voltage to be applied to the main battery or the auxiliary battery according to a level of the external voltage when a charging mode for charging the main battery and the auxiliary battery is performed, wherein the motor system is configured to step down and output a voltage of the main battery to the auxiliary battery when the external voltage is applied to the main battery, and is configured to boost and output a voltage of the auxiliary battery to the main battery when the external voltage is applied to the auxiliary battery.

Furthermore, in various aspects of the present disclosures, there is provided a method of charging the batteries of the electric vehicle, the method including: controlling an external voltage to be applied to a main battery or an auxiliary battery of the vehicle according to a level of the external voltage when a charging mode is performed: charging the auxiliary battery by stepping down a voltage of the main battery through a motor system including a motor and an inverter when the external voltage is applied to the main battery: and charging the main battery by boosting a voltage of the auxiliary battery through the motor system when the external voltage is applied to the auxiliary battery.

According to an exemplary embodiment of the present disclosure, the main battery is charged with the auxiliary battery through a motor system while driving of the vehicle of an electric vehicle, efficiently increase the driving distance of the electric vehicle.

Furthermore, according to an exemplary embodiment of the present disclosure, the main battery and the auxiliary battery may be efficiently charged through the motor system regardless of the level of the external voltage during fast charging.

Effects obtainable from the present disclosure are not limited to the effects described above, and other effects not described above will be clearly appreciated from the following description by those skilled in the art.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The following drawings attached to the present specification illustrate exemplary embodiments of the present disclosure, and together with the detailed description of the present disclosure, serve to promote the understand of the technical idea of the present disclosure, so that the present disclosure should not be construed as limited to matters described in the drawings.

FIG. 1 is a view exemplarily illustrating a battery charging system of an electric vehicle according to various exemplary embodiments of the present disclosure:

FIG. 2 and FIG. 3 are views exemplarily illustrating a process in which the electric vehicle is configured to perform a fast charging mode according to the various exemplary embodiments of the present disclosure:

FIG. 4 is a circuit diagram illustrating the configuration of a motor system according to the various exemplary embodiments of the present disclosure:

FIG. 5 is a waveform diagram illustrating the operation of a controller configured for controlling the switching state of an inverter in the fast charging mode according to the various exemplary embodiments of the present disclosure;

FIG. 6 is the waveform diagram of the phase currents of a motor and the current of an auxiliary battery when a charging mode while driving is performed according to the various exemplary embodiments of the present disclosure:

FIG. 7 and FIG. 8 are waveform diagrams illustrating the operation of the controller configured for controlling the switching state of the inverter in the charging mode while driving according to the various exemplary embodiments of the present disclosure;

FIG. 9 is a circuit diagram illustrating the configuration of the motor system according to various exemplary embodiments of the present disclosure; and

FIG. 10, FIG. 11, and FIG. 12 are flowcharts illustrating the control method of an electric vehicle according to the various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, but the same or similar components regardless of reference numerals are assigned the same reference numerals, and overlapping descriptions thereof will be omitted.

In the description of the following embodiments, the term “preset” means that the value of a parameter is predetermined when using the parameter in a process or algorithm. Depending on the embodiments, the value of the parameter may be preset when a process or algorithm starts or may be preset during a period during which the process or algorithm is performed.

Terms “module” and “part” for the components used in the following description are provided or mixed in consideration of only the ease of writing the specification, and do not have distinct meanings or roles by themselves.

In addition, when it is determined that detailed descriptions of related known technologies may obscure the gist of the exemplary embodiments included in the present specification in describing the exemplary embodiments included in the present specification, the detailed description thereof will be omitted. Furthermore, the accompanying drawings are only for easily understanding the exemplary embodiments included in the present specification, and do not limit the technical idea included herein, and should be understood to cover all modifications, equivalents or substitutes falling within the spirit and scope of the present disclosure.

Terms including an ordinal number, such as first and second, etc., may be used to describe various elements, but the elements are not limited by the terms. The terms are used only for distinguishing one element from another.

It should be understood that when an element is referred to as being “coupled” or “connected” to another element, it may be directly coupled or connected to the another element, or intervening elements may be present therebetween. On the other hand, it should be understood that when an element is referred to as being “directly coupled” or “directly connected” to another element, there are no intervening elements present.

Singular forms include plural forms unless the context clearly indicates otherwise.

In the present specification, it should be understood that terms such as “comprises” or “have” are intended to designate that features, numbers, steps, operations, components, parts, or combinations thereof described in the specification exist, but do not preclude the possibility of the existence or addition of one or more other features, numbers, steps, operations, components, parts, or combinations thereof.

Furthermore, the terms “unit” and “control unit” included in the names “hybrid control unit (HCU)” and “vehicle control unit (VCU)” are only terms widely used in the naming of a controller that is configured to control the specific function of a vehicle, but do not mean a generic function unit. For example, each control unit may include a communication device which communicates with other control units or sensors for controlling a function in charge, a memory which stores an operating system, a logic command, or input/output information, and at least one processor which is configured to perform judgment, determination, and determination necessary for controlling the function in charge.

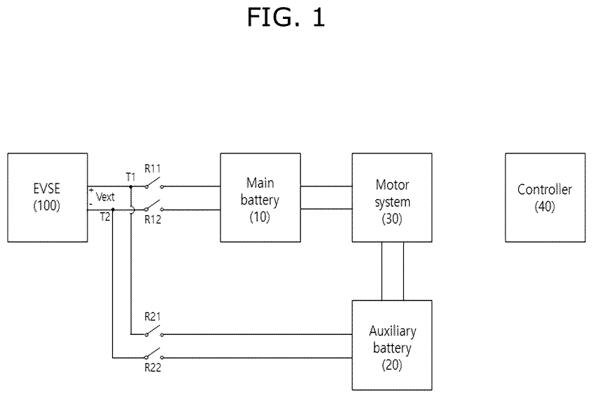

FIG. 1 is a view exemplarily illustrating a battery charging system of an electric vehicle according to various exemplary embodiments of the present disclosure

As illustrated in FIG. 1, the battery charging system of the electric vehicle may include a main battery 10, an auxiliary battery 20, a motor system 30, a controller 40, and a plurality of relays R11, R12, R21, and R22.

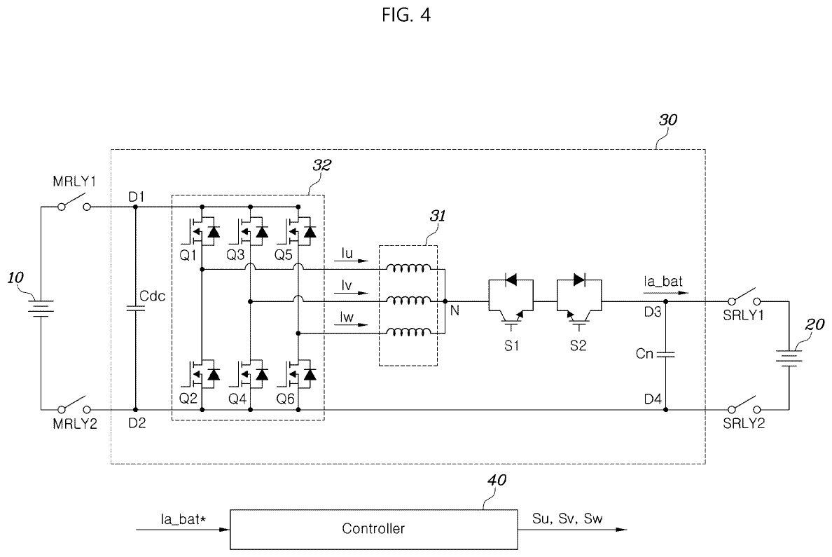

The motor system 30 includes a motor and an inverter, and may be connected to the main battery 10 and the auxiliary battery 20 by being located therebetween. The motor system 30 may operate the motor through the inverter based on the voltage of the main battery 10 during a motor drive mode. Furthermore, while operating the motor through the inverter based on the voltage of the main battery 10 in a charging mode while driving, the motor system 30 may transmit power of the auxiliary battery 20, which is connected electrically to a neutral end of the motor, to the main battery 10, or may transmit power of the main battery 10 to the auxiliary battery 20. The configuration and operating method of the motor system 30 will be described later in detail with reference to FIG. 4.

The controller 40 may control the short-circuit state of the plurality of relays R11, R12, R21, and R22 and the switching state of the inverter included in the motor system 30. In the implementation, the controller 40 may be implemented as a single controller or a plurality of controllers having distributed functions. For example, the controller 40 may be implemented as a combination of a motor control unit (MCU) which is configured to control the motor of the motor system 30 and a control unit superior thereto (e.g., a hybrid control unit (HCU), a vehicle control unit (VCU), and a hydrogen fuel cell control unit (FCCU), etc.), but is not necessarily limited thereto. According to another implementation, the controller 40 may further include a charge controller.

When the electric vehicle stops, the battery charging system according to the exemplary embodiment of the present disclosure may receive an external DC voltage Vext from electric vehicle supply equipment 100 (hereinafter, referred to as EVSE) and may perform a fast charging mode in which the main battery 10 and the auxiliary battery 20 are charged through the motor system 30.

In the instant case, the voltage of the main battery 10 and the voltage of the auxiliary battery 20 may be preset to be different. For example, the auxiliary battery 20 may have a lower voltage than the voltage of the main battery 10.

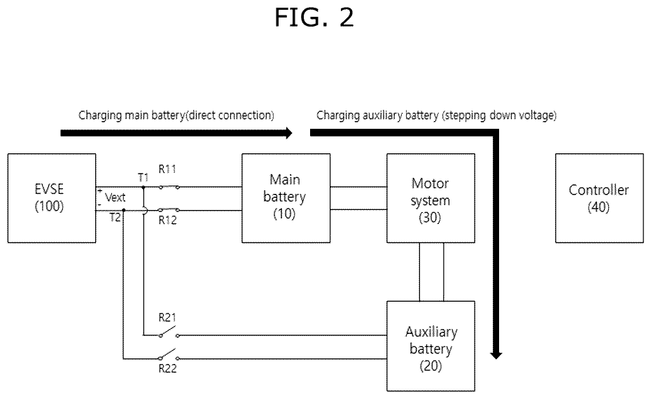

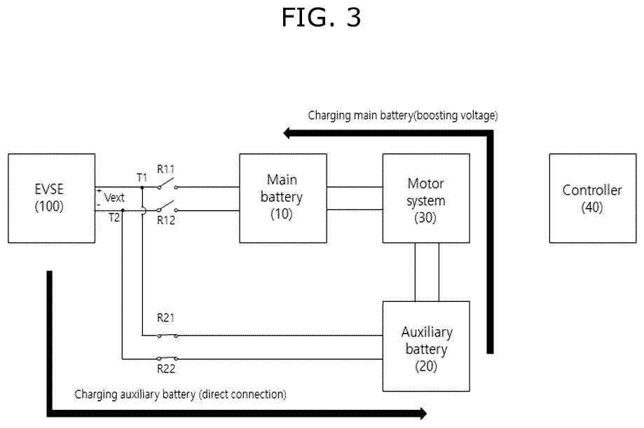

Accordingly, the battery charging system may control the charging of the main battery 10 and the auxiliary battery 20 in different ways according to the level of the external DC voltage Vext applied from EVSE in the fast charging mode. This will be described in detail with reference to FIG. 2 and FIG. 3.

FIG. 2 and FIG. 3 are views exemplarily illustrating a process in which the electric vehicle is configured to perform the fast charging mode according to the various exemplary embodiments of the present disclosure.

FIG. 2 illustrates a case in which the level of the external DC voltage Vext corresponds to the level of the voltage of the main battery 10, and FIG. 3 illustrates a case in which the level of the external DC voltage Vext corresponds to the level of the voltage of the auxiliary battery 20. For example, when the voltages of the main battery 10 and the auxiliary battery 20 are 800V and 400V, respectively, FIG. 2 may be a case in which the external DC voltage Vext receives 800V from EVSE, and FIG. 3 may be a case in which the external DC voltage Vext receives 400V from EVSE.

Referring to FIG. 2, when the level of the external DC voltage Vext corresponds to the level of the voltage of the main battery 10 in the fast charging mode, the controller 40 may control the external DC voltage Vext to be applied to the main battery 10 by shorting the relays R11 and R12 and opening the relays R21 and R22. That is, when the fast charging mode is performed, the main battery 10 may be charged while being directly connected to a positive terminal T1 and a negative terminal T2 to which the external DC voltage Vext is applied.

In the instant case, the relay R11 may be connected to the positive terminal T1 and the positive pole of the main battery 10 by being located therebetween, and the relay R12 may be connected to the negative terminal T2 and the negative pole of the main battery 10 by being located therebetween. Furthermore, the relay R21 may be connected to the positive terminal T1 and the positive pole of the auxiliary battery 20 by being located therebetween, and the relay R22 may be connected to the negative terminal T2 and the negative pole of the auxiliary battery 20 by being located therebetween.

Furthermore, when the level of the external DC voltage Vext corresponds to the level of the voltage of the main battery 10 in the fast charging mode, the controller 40 may control the motor system 30 to boost and output the voltage of the main battery 10 to the auxiliary battery 20 so that the auxiliary battery 20 may be charged.

Referring to FIG. 3, when the level of the external DC voltage Vext corresponds to the level of the voltage of the auxiliary battery 20 in the fast charging mode, the controller 40 may control the external DC voltage Vext to be applied to the auxiliary battery 20 by opening the relays R11 and R12 and shorting the relays R21 and R22. That is, when the fast charging mode is performed, the auxiliary battery 20 may be charged while being directly connected to the positive terminal T1 and the negative terminal T2 to which the external DC voltage Vext is applied.

Furthermore, when the level of the external DC voltage Vext corresponds to the level of the voltage of the auxiliary battery 20 in the fast charging mode, the controller 40 may control the motor system 30 to boost and output the voltage of the auxiliary battery 20 to the main battery 10 so that the main battery 10 may be charged.

Accordingly, when the fast charging mode is performed, the battery charging system according to the exemplary embodiment of the present disclosure may efficiently charge the main battery 10 and the auxiliary battery 20 through the motor system 30 regardless of the level of the external DC voltage Vext.

Furthermore, the battery charging system according to the exemplary embodiment is configured to perform the fast charging mode through one motor system, and thus may be applied not only to a four-wheel drive system provided with two motor systems, but also to a two-wheel drive system provided with one motor system.

As described above, the motor system 30 may perform the fast charging mode performed while the vehicle stops, and the motor drive mode and the charging mode while driving performed while the vehicle is driving. A structure for this is illustrated in FIG. 4.

FIG. 4 is a circuit diagram illustrating the configuration of the motor system according to the various exemplary embodiments of the present disclosure.

Referring to FIG. 4, the motor system 30 may include the motor 31, the inverter 32, the charging switches S1 and S2, and DC capacitors Cdc and Cn. Furthermore, the motor system 30 may have DC ends D1 and D2 connected to the main battery 10 through main relays MRLY1 and MRLY2, respectively, and DC ends D3 and D4 connected to the auxiliary battery 20 through sub relays SRLY1 and SRLY2, respectively.

The main relay MRLY1 may be connected to the positive pole of the main battery 10 and the DC end D1 by being located therebetween, and the main relay MRLY2 may be connected to the negative pole of the main battery 10 and the DC end D2 by being located therebetween. The DC capacitor Cdc may be connected to the DC end D1 and the DC end D2 by being located therebetween to step down the ripple of the current of the main battery 10.

The sub relay SRLY1 may be connected to the positive pole of the auxiliary battery 20 and the DC end D3 by being located therebetween, and the sub relay SRLY2 may be connected to the negative pole of the auxiliary battery 20 and the DC end D4 by being located therebetween. The DC capacitor Cn may be connected to the DC end D3 and the DC end D4 by being located therebetween to step down the ripple of the current of the auxiliary battery 20.

The motor 31 may include a plurality of coils corresponding to a plurality of phases, respectively.

The inverter 32 may have the DC ends D1 and D2 connected to the main battery 10 through the main relays MRLY1 and MRLY2, and may include a plurality of legs Q1-Q2, Q3-Q4, and Q5-Q6 connected respectively to the plurality of coils included in the motor 31. Furthermore, the inverter 32 may receive a plurality of switching signals Su, Sv, and Sw corresponding to the plurality of phases, respectively, from the controller 40, and may switch the plurality of legs Q1-Q2, Q3-Q4, and Q5-Q6 based on the plurality of switching signals Su, Sv, and Sw.

The charging switches S1 and S2 may be connected to each other in series between the neutral end N of the motor 31 and the positive pole of the auxiliary battery 20. The collector end of the charging switch S1 may be connected to the neutral end N, the collector end of the charging switch S2 may be connected to the positive pole of the auxiliary battery 20 through the sub relay SRLY1, and the drain ends of the charging switches S1 and S2 may be connected to each other to form a common node. Accordingly, when the charging switches S1 and S2 are turned off, the diode of each of the charging switches S1 and S2 may block the current of the neutral end N from flowing to the DC end D3. In the exemplary embodiment of the present disclosure, the charging switches S1 and S2 are configured as an insulated gate bipolar transistor (IGBT), but may be configured as a MOSFET according to an exemplary embodiment of the present disclosure.

Hereinafter, a method in which the controller 40 is configured to control the motor system 30 for each of the fast charging mode, the charging mode while driving, and the motor drive mode will be described.

When the fast charging mode is performed, the controller 40 turns on the charging switches S1 and S2, and may electrically connect the neutral end N with the positive pole of the auxiliary battery 20 while the charging switches S1 and S2 are turned on.

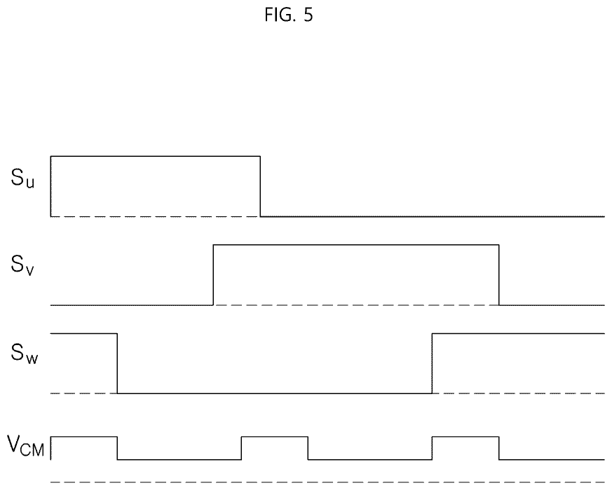

When the fast charging mode is performed, the controller 40 may be configured to generate the plurality of switching signals Su, Sv, and Sw corresponding to the plurality of phases, respectively, through interleaved PWM control. In the instant case, based on the plurality of switching signals Su, Sv, and Sw, the motor system 30 may step down and output the voltage of the main battery 10 to the auxiliary battery 20, or may boost and output the voltage of the auxiliary battery 20 to the main battery 10. Here, the interleaved PWM control may refer to a method of generating the plurality of switching signals Su, Sv, and Sw with a phase difference of 120° from each other. Referring to FIG. 5, when the controller 40 performs the interleaved PWM control, an example of waveforms for the plurality of switching signals Su, Sv, and Sw and a common mode voltage VCM is illustrated. Here, the common mode voltage VCM may correspond to a potential difference between the ground terminal and the neutral end N.

Referring back to FIG. 4, when the charging mode while driving is performed, the controller 40 turns on the charging switches S1 and S2, and may electrically connect the neutral end N with the positive pole of the auxiliary battery 20 while the charging switches S1 and S2 are turned on.

When the charging mode while driving is performed, the controller 40 may be configured to generate the plurality of switching signals Su, Sv, and Sw for applying the direct current (DC) offset to each of the phase currents Iu, Iv and Iw of the motor 31 having the plurality of phases based on a charging current command Ia_bat* for the auxiliary battery 20. The controller 40 may divide the value of the charging current command Ia_bat* by the number (e.g., 3) of the plurality of phases to generate a zero-phase current command for the direct current (DC) offset, and may be configured to generate the plurality of switching signals Su, Sv, and Sw based on the zero-phase current command. In the instant case, based on the plurality of switching signals Su, Sv, and Sw, the motor system 30 may transmit power of the auxiliary battery 20 to the main battery 10, or may transmit power of the main battery 10 to the auxiliary battery 20.

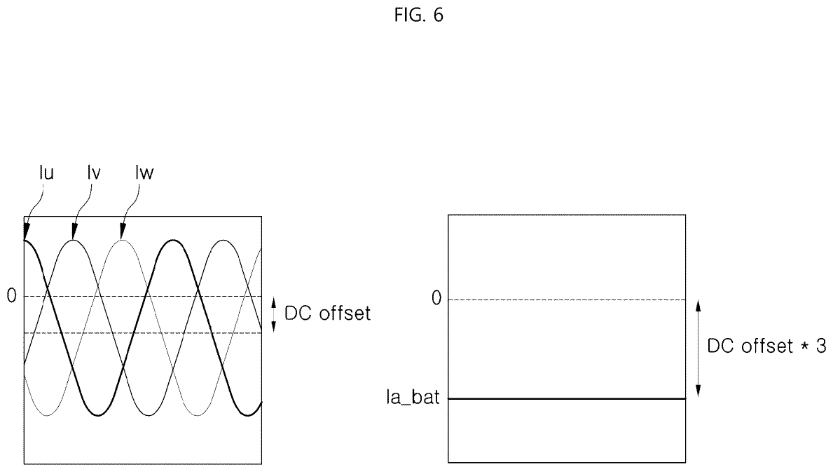

Referring to FIG. 6, when the charging mode while driving is performed, an example of waveforms for the phase currents Iu, Iv and Iw of the motor 31 and the charging current Ia_bat of the auxiliary battery 20 is illustrated. Each of the phase currents Iu, Iv and Iw of the motor may have the direct current (DC) offset and may have phase difference of 120° from each other. The charging current Ia_bat is equal to the sum of the phase currents Iu, Iv and Iw of the motor 31, and thus may have a DC waveform obtained by multiplying the direct current (DC) offset by the number (e.g., 3) of the plurality of phases. Accordingly, when the controller 40 applies a negative direct current (DC) offset to each of the phase currents Iu, Iv and Iw of the motor, the charging current Ia_bat is output from the auxiliary battery 20 to the main battery 10, and thus the motor system 30 may transmit the power of the auxiliary battery 20 to the main battery 10. Contrarily, when the controller 40 applies a positive direct current (DC) offset to each of the phase currents Iu, Iv and Iw of the motor, the charging current Ia_bat is output from the main battery 10 to the auxiliary battery 20, and thus the motor system 30 may transmit the power of the main battery 10 to the auxiliary battery 20.

When the charging mode while driving is performed, the controller 40 may be configured to generate the plurality of switching signals Su, Sv, and Sw for applying the direct current (DC) offset to each of the phase currents Iu, Iv and Iw of the motor through space vector pulse width modulation (SVPWM) control or remote state pulse width modulation (RSPWM) control. Here, the SVPWM control may refer to a method of synthesizing a reference voltage vector by use of a zero voltage vector in a complex space and two effective voltage vectors adjacent to the reference voltage vector. Furthermore, the RSPWM control may refer to a method of synthesizing a reference voltage vector by use of three effective voltage vectors with a phase difference of 120° from each other in a complex space.

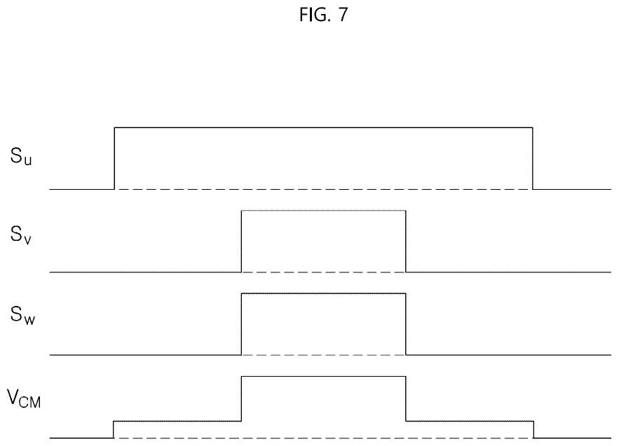

Referring to FIG. 7, when the controller 40 performs the SVPWM control, an example of waveforms of the plurality of switching signals Su, Sv, and Sw and the common mode voltage V_{CM} is illustrated. In the instant case, each of the switching signals Su, Sv, and Sw may have a center-aligned waveform within one duty cycle. When the SVPWM control is performed, the maximum amplitude of the common mode voltage VCM may correspond to the voltage of the main battery 10.

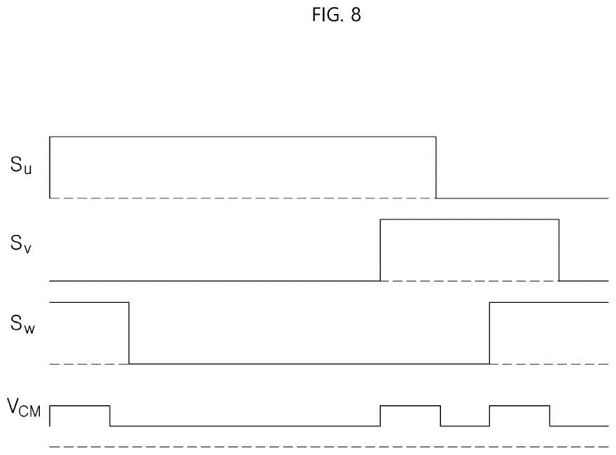

Referring to FIG. 8, when the controller 40 performs the RSPWM control, an example of waveforms of the plurality of switching signals Su, Sv, and Sw and the common mode voltage V_{CM} is illustrated. When the RSPWM control is performed, the maximum amplitude of the common mode voltage VCM may correspond to a value obtained by dividing the voltage of the main battery 10 by 3. That is, the pulsation of the common mode voltage VCM occurs less in the RSPWM control of FIG. 8 than in the SVPWM control of FIG. 7, and thus the controller 40 may step down a current ripple generated in the neutral end of the motor 31 through the RSPWM control in the charging mode while driving.

Referring back to FIG. 4, when the motor drive mode is performed, the controller 40 turns off the charging switches S1 and S2, and may electrically separate the neutral end N from the positive pole of the auxiliary battery 20 while the charging switches S1 and S2 are turned off.

When the motor drive mode is performed, the controller 40 may be configured to generate the plurality of switching signals Su, Sv, and Sw through the control of the space vector pulse width modulation (SVPWM) without the application of the direct current (DC) offset to each of the phase currents Iu, Iv and Iw of the motor 31.

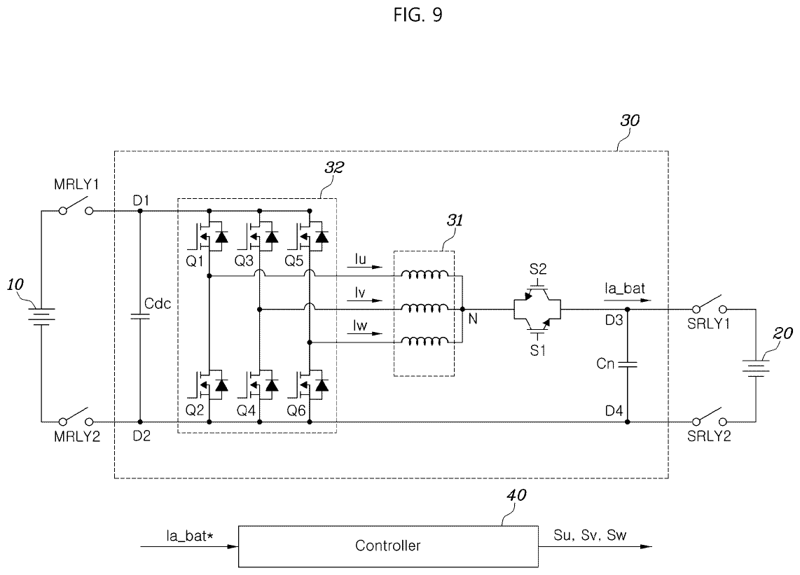

FIG. 9 is a circuit diagram illustrating the configuration of the motor system according to various exemplary embodiments of the present disclosure.

Referring to FIG. 9, the charging switch S1 and the charging switch S2 may be connected to each other in parallel between the neutral end N and the positive pole of the auxiliary battery 20. The collector end of the charging switch S1 and the emitter end of the charging switch S2 may be connected to the neutral end N, and the emitter end of the charging switch S1 and the collector end of the charging switch S2 may be connected to the positive pole of the auxiliary battery 20 through the sub relay SRLY1. Accordingly, while the charging switches S1 and S2 are turned off, the neutral end N and the DC end D3 may be electrically separated from each other. In the connection state of FIG. 9, when the charging switches S1 and S2 are turned on, only one of the charging switches S1 and S2 is in a conducting state according to the direction of the current of the neutral end N, and thus the conduction loss of the charging switches S1 and S2 may be minimized. In the instant case, the charging switches S1 and S2 may be configured as transistors (e.g., IGBTs) without reverse conduction characteristics.

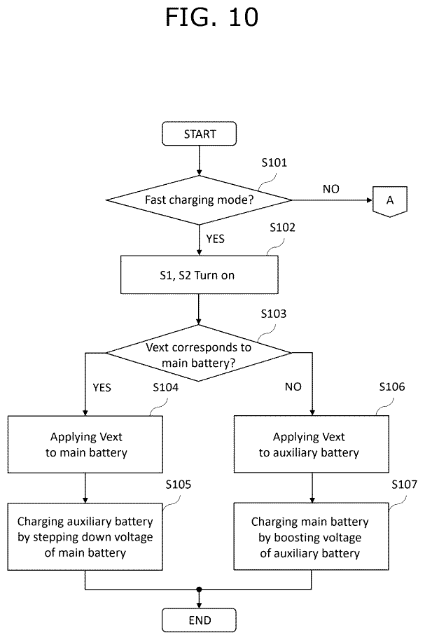

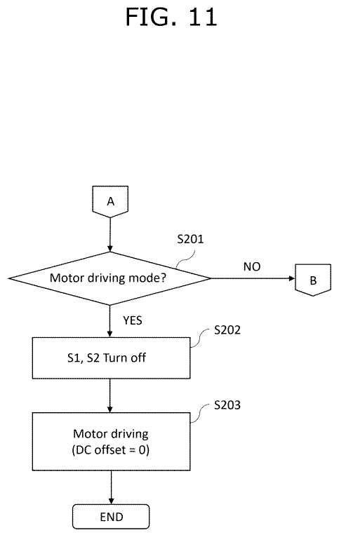

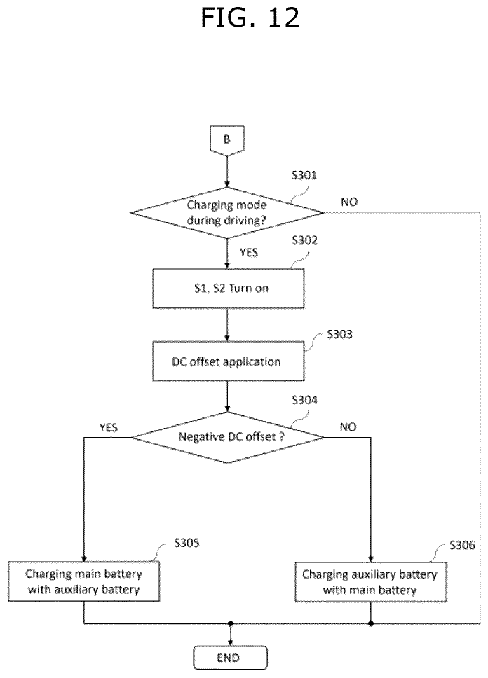

FIG. 10, FIG. 11, and FIG. 12 are flowcharts illustrating the control method of an electric vehicle according to the various exemplary embodiments of the present disclosure.

Referring to FIG. 10, the controller 40 may be configured to determine whether to perform the fast charging mode at S101.

When the fast charging mode is performed (YES of S101), the controller 40 may turn on the charging switches S1 and S2, and may electrically connect the neutral end of the motor 31 with the positive pole of the auxiliary battery 20 while the charging switches S1 and S2 are turned on at S102.

Furthermore, when the fast charging mode is performed (YES of S101, the controller 40 may be configured to determine whether the level of the external DC voltage Vext corresponds to the level of the voltage of the main battery 10 at S103, and according to the result of the determination, may control the external DC voltage Vext to be applied to the main battery 10 at S104 or the auxiliary battery 20 at S106.

When the level of the external DC voltage Vext corresponds to the level of the voltage of the main battery 10 (YES of S103), the controller 40 may short the relays R11 and R12 connected to the terminals T1 and T2, to which the external DC voltage Vext is applied, and the main battery 10 by being located therebetween, and may control the external DC voltage Vext to be applied the main battery 10 at S104. When the external DC voltage Vext is applied to the main battery 10, the controller 40 may step down the voltage of the main battery 10 through the motor system 30 to charge the auxiliary battery 20 at S105.

Unlike this, when the level of the external DC voltage Vext corresponds to the level of the voltage of the auxiliary battery 20 (NO of S103), the controller 40 may short the relays R21 and R22 connected to the terminals T1 and T2, to which the external DC voltage Vext is applied, and the auxiliary battery 20 by being located therebetween, and may control the external DC voltage Vext to be applied to the auxiliary battery 20 at S106. When the external DC voltage Vext is applied to the auxiliary battery 20, the controller 40 may boost the voltage of the auxiliary battery 20 through the motor system 30 to charge the main battery 10 at S107.

Referring to FIG. 11, the controller 40 may be configured to determine whether to perform the motor drive mode at S201.

When the motor drive mode is performed (YES of S201), the controller 40 turns off the charging switches S1 and S2, and may electrically separate the neutral end of the motor 31 from the positive pole of the auxiliary battery 20 while the charging switches S1 and S2 are turned off at S202.

Furthermore, when the motor drive mode is performed (YES of S201), the controller 40 may operate the motor 31 by controlling the switching state of the inverter 32 without the direct current (DC) offset to each of the phase currents of the motor 31 having the plurality of phases at S203.

Referring to FIG. 12, the controller 40 may be configured to determine whether to perform the charging mode while driving at S301.

When the charging mode while driving is performed (YES of S301), the controller 40 may turn on the charging switches S1 and S2 and may electrically connect the neutral end of the motor 31 with the positive pole of the auxiliary battery 20 while the charging switches S1 and S2 are turned on at S302.

Furthermore, when the charging mode while driving is performed (YES of S301), the controller 40 may apply the direct current (DC) offset to each of the phase currents of the motor 31 having the plurality of phases at S303. In the instant case, the controller 40 may be configured to determine the sign of the direct current (DC) offset according to the charging current command Ia_bat* for the auxiliary battery 20 at S304.

When the direct current (DC) offset is negative (YES of S304), the motor system 30 may transmit power of the auxiliary battery 20 to the main battery 10 to discharge the auxiliary battery 20 so that the main battery 10 may be charged at S305.

When the direct current (DC) offset is positive (NO of S304), the motor system 30 may transmit power of the main battery 10 to the auxiliary battery 20 to discharge the main battery 10 so that the auxiliary battery 20 may be charged at S306.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle comprising:
a main battery and an auxiliary battery;
a motor system including a motor and an inverter and connected to the main battery and the auxiliary battery; and
a controller which is configured to control an external voltage to be applied to the main battery or the auxiliary battery according to a level of the external voltage when a charging mode for charging the main battery and the auxiliary battery is performed,
wherein the motor system is configured to step down and output a voltage of the main battery to the auxiliary battery when the external voltage is applied to the main battery, and is configured to boost and output a voltage of the auxiliary battery to the main battery when the external voltage is applied to the auxiliary battery.

2. The vehicle of claim 1, wherein the controller is configured to control the external voltage to be applied to the main battery when the controller concludes that the level of the external voltage corresponds to a level of the voltage of the main battery, and is configured to control the external voltage to be applied to the auxiliary battery when the controller concludes that the level of the external voltage corresponds to a level of the voltage of the auxiliary battery.

3. The vehicle of claim 2, further including:
a first relay connected between a terminal to which the external voltage is applied and the main battery; and
a second relay connected between the terminal to which the external voltage is applied and the auxiliary battery,
wherein the controller is configured to short the first relay when the level of the external voltage corresponds to the level of the voltage of the main battery, and to short the second relay when the level of the external voltage corresponds to the level of the voltage of the auxiliary battery.

4. The vehicle of claim 1, wherein when the charging mode is performed, the controller is configured to turn on a charging switch connected between a neutral end of the motor and one pole of the auxiliary battery.

5. The vehicle of claim 1,
wherein the charging switch is in plural and the plurality of charging switches include a first charging switch and a second charging switch connected to the first charging switch in series, and
wherein an end of the first charging switch is connected to the neutral end of the motor and an end of the second charging switch is connected to the one pole of the auxiliary battery.

6. The vehicle of claim 1,
wherein the charging switch is in plural and the plurality of charging switches include a first charging switch and a second charging switch connected to the first charging switch in parallel, and
wherein a first end of the first charging switch and a first end of the second charging switch are connected to the neutral end of the motor and a second end of the first charging switch and a second end of the second charging switch is connected to the one pole of the auxiliary battery.

7. The vehicle of claim 1, wherein when the charging mode is performed, the controller is configured to generate a plurality of switching signals for switching a plurality of legs of the inverter, with each of the switching signals having a phase difference of 120° from each other.

8. The vehicle of claim 1,
wherein when a charging mode while driving of the vehicle is performed, the controller is configured to apply a direct current (DC) offset to each of phase currents of the motor having a plurality of phases, and
wherein the motor system is configured to transmit power of the auxiliary battery to the main battery when the direct current (DC) offset is negative, and to transmit power of the main battery to the auxiliary battery when the direct current (DC) offset is positive.

9. The vehicle of claim 8,
wherein the controller is configured to turn on a charging switch connected between a neutral end of the motor and one pole of the auxiliary battery when the charging mode while driving of the vehicle is performed, and to turn off the charging switch when a motor drive mode is performed.

10. The vehicle of claim 8, wherein when the charging mode while driving of the vehicle is performed, the controller is configured to generate a zero-phase current command for the direct current (DC) offset by dividing a value of a charging current command for the auxiliary battery by a number of the plurality of phases, and to generate a plurality of switching signals for switching a plurality of legs of the inverter based on the zero-phase current command.

11. A method of controlling a vehicle, the method comprising:
controlling, by a controller, an external voltage to be applied to a main battery or an auxiliary battery of the vehicle according to a level of the external voltage when a charging mode is performed;
charging, by a motor system including a motor and an inverter, the auxiliary battery by stepping down a voltage of the main battery when the external voltage is applied to the main battery; and
charging, by the motor system, the main battery by boosting a voltage of the auxiliary battery when the external voltage is applied to the auxiliary battery.

12. The method of claim 11, wherein the controlling includes:
applying the external voltage to the main battery when the controller concludes that the level of the external voltage corresponds to a level of the voltage of the main battery; and
applying the external voltage to the auxiliary battery when the controller concludes that the level of the external voltage corresponds to a level of the voltage of the auxiliary battery.

13. The method of claim 12,
wherein the applying of the external voltage to the main battery includes shorting a first relay connected between a terminal to which the external voltage is applied and the main battery, and
wherein the applying of the external voltage to the auxiliary battery includes shorting a second relay connected between the terminal to which the external voltage is applied and the auxiliary battery.

14. The method of claim 11, further including:
turning on, by the controller, a charging switch connected between a neutral end of the motor and one pole of the auxiliary battery when the charging mode is performed.

15. The method of claim 11, further including:
applying, by the controller, a direct current (DC) offset to each of phase currents of the motor having a plurality of phases when the charging mode while driving of the vehicle is performed; and
transmitting, by the motor system, power of the auxiliary battery to the main battery when the direct current (DC) offset is negative.

16. The method of claim 15, further including:
turning on, by the controller, a charging switch connected between a neutral end of the motor and one pole of the auxiliary battery when the charging mode while driving of the vehicle is performed.

17. The method of claim 11, further including:
applying, by the controller, a direct current (DC) offset to each of phase currents of the motor having a plurality of phases when the charging mode while driving of the vehicle is performed; and
transmitting, by the motor system, power of the main battery to the auxiliary battery when the direct current (DC) offset is positive.

18. The method of claim 17, further including:
turning on, by the controller, a charging switch connected between a neutral end of the motor and one pole of the auxiliary battery when the charging mode while driving of the vehicle is performed.

19. A non-transitory computer readable storage medium on which a program for performing the method of claim 11 is recorded.
